(19) United States
(12) Patent Application Publication
(10) Pub. No.: US 2011/0079944 A1
(43) Pub. Date: Apr. 7, 2011

(54) ALLOY FOR SPRING, PLATE MATERIAL FOR SPRING, AND SPRING MEMBER

(76) Inventors: Yasunori Akasaka, Chiba-shi (JP); Kyotaro Takahashi, Chiba-shi (JP); Takashi Kamada, Chiba-shi (JP); Ryo Sugawara, Chiba-shi (JP); Tomoo Kobayashi, Chiba-shi (JP)

(21) Appl. No.: 12/894,982

(22) Filed: Sep. 30, 2010

(30) Foreign Application Priority Data
Oct. 2, 2009 (JP) 2009-230619

(51) Int. Cl. F16F 1/10; C22C 30/00

(52) U.S. Cl. 267/156; 420/586; 148/442

(57) ABSTRACT

Provided are an alloy for spring, a plate material for spring, and a spring member, all of which are high in mechanical strength, also high in fatigue strength, and excellent in corrosion resistance. An alloy for spring of the present invention includes, as composition in terms of weight ratio, 28 to 42% Co, 10 to 27% Cr, 3 to 12% Mo, 15 to 40% Ni, 0.1 to 1.0% Ti, 1.5% or less Mn, 0.1 to 26.0% Fe, 0.1% or less C, and inevitable impurities, and at least one kind selected from 3.0% or less Nb, 5.0% or less W, 0.5% or less Al, 0.1% or less Zr, and 0.01% or less B.

### RELATED APPLICATIONS

This application claims priority under 35 U.S.C. §119 to Japanese Patent Application No. 2009-230619 filed on Oct. 2, 2009, the entire content of which is hereby incorporated by reference.

### BACKGROUND OF THE INVENTION

1. Field of the Invention

The present invention relates to an alloy for spring, a plate material for spring, and a spring member.

2. Description of the Related Art

In recent years, there have been widely used sliding mobile phones. In each of the mobile phones, a body provided with an operation key and a transmission part and a lid body arranged so as to overlap the body and provided with a display and a receiver part are slid along the overlapped faces of the two bodies, thereby opening or closing the mobile phone. The sliding mobile phones each include a hinge mechanism using a spring member. The sliding mobile phones each have such a configuration that the movement of the lid body causes the elastic deformation of the spring member, and the restoring force (energizing force) of the elastic deformation is used to energize the lid body in the opening direction or in the closing direction.

In general, a torsion spring is used as the above-mentioned spring member used in the hinge mechanism from the viewpoints of easy production, low lost, and the like. The torsion spring has a winding portion formed by winding a wire rod in a coil shape in a three-dimensional fashion, and has both ends of parts stretching from the winding portion. It is said that the attachment of the torsion spring can be performed by using both the ends. For example, when the torsion spring is adopted in each of the above-mentioned sliding mobile phones, the torsion spring can be attached in the sliding mobile phone by connecting one of the ends of the parts stretching from the winding portion to the body side and connecting the other end to the lid body side. It is said that by adopting the torsion spring, the restoring force of the winding portion can be used to energize the lid body in the opening direction or in the closing direction.

By the way, as technological progress has proceeded in recent years, reductions in sizes of various devices (such as mobile phones) on which hinge mechanisms are mounted have proceeded. In order that further reductions in sizes of those the devices in the future may be attempted, demanded are reductions in size and thickness of a spring member, or particularly demanded is the reduction in thickness.

For example, it is known that Japanese Patent Application Laid-open No. 2009-188753 discloses a torsion spring having a winding portion formed by winding a wire rod in a spiral shape. This describes that the thickness of the winding portion can be controlled so as to be as small as possible.

However, although the above-mentioned spring had a spiral winding portion, the winding portion was formed by winding a wire rod in a three-dimensional fashion, resulting in an inevitable thickness of the spring. Thus, it was difficult to attempt a further reduction in thickness.

Further, when winding was performed, more stress was concentrated on a place where the curvature of the winding was smaller, and hence the strength of the spring was likely to be irregular as a whole. In addition, fatigue caused by winding was likely to be accumulated in a wire rod. Because of the above reasons, it was difficult to impart sufficient durability to the spring.

It should be noted that, if a winding portion was produced by winding a wire rod in a two-dimensional fashion, a reduction in size could be attempted. However, the attempt is technologically difficult and necessary strength is difficult to be provided.

In order to attain a reduction in size of a sliding mobile device, a spring functioning in a sliding mechanism is desirably as thin as possible. A reduction in thickness of a spring formed by winding a wire rod in a coil shape or in a spiral shape is performed with some limitations because of the structure of the spring. Meanwhile, a spring formed by using a flat wire rod had problems in that the spring was unable to ensure necessary mechanical strength (hardness and tensile strength) and did not have sufficient durability.

### SUMMARY OF THE INVENTION

The present invention has been made in view of the above-mentioned circumstances. An object of the present invention is to provide an alloy for spring, a plate material for spring, and a spring member, all of which are high in mechanical strength, also high in fatigue strength, and excellent in corrosion resistance.

The present invention has adopted the following constitution for accomplishing the above-mentioned object.

An alloy for spring according to a first aspect of the present application includes, as composition in terms of weight ratio, 28 to 42% Co, 10 to 27% Cr, 3 to 12% Mo, 15 to 40% Ni, 0.1 to 1.0% Ti, 1.5% or less Mn, 0.1 to 26.0% Fe, 0.1% or less C, and inevitable impurities, and at least one kind selected from 3.0% or less Nb, 5.0% or less W, 0.5% or less Al, 0.1% or less Zr, and 0.01% or less B.

An alloy for spring according to a second aspect of the present application is an alloy for spring according to the first aspect, in which Fe is incorporated at 0.1 to 3.0%, and the at least one kind is selected from 3.0% or less Nb, 5.0% or less W, 0.1% or less Zr, and 0.01% or less B.

An alloy for spring according to a third aspect of the present application is an alloy for spring according to the second aspect, in which 3.0% or less Nb is selected as the at least one kind.

A plate material for spring according to a fourth aspect of the present application is formed by subjecting the alloy for spring according to any one of the first to third aspects to cold working into a plate shape at a rate of work of 20% or more.

A plate material for spring according to a fifth aspect of the present application is formed by subjecting the plate material for spring according to the fourth aspect to heat treatment at from 200° C. to 730° C. in one of a vacuum and a nonoxidizing atmosphere.

A spring member according to a sixth aspect of the present application is formed from the plate material for spring according to the fourth or fifth aspect by unwinding work, has the same thickness as that of the plate material, and extends in a plane direction of the plate material.

The alloy for spring of the present invention is high in mechanical strength and in fatigue strength, and hence the alloy for spring is suitable as a material to be used for producing a spring functioning in a sliding mechanism in a sliding mobile device or the like.

The plate material for spring of the present invention is formed by undergoing work hardening by two methods, the two methods including a method involving subjecting an alloy containing Co, Ni, and Cr as main components to cold working, thereby causing solute atoms such as Mo, Nb, and Fe to segregate in a dislocation core or in a stacking fault of extended dislocation to prevent easy occurrence of cross slip, and a method involving causing fine deformation twins to form, thereby blocking slip dislocation, and hence the plate material for spring is high in mechanical strength. Further, when the plate material for spring is subjected to aging treatment afterwards, static strain aging causes age hardening, resulting in a plate material for spring higher in mechanical strength.

The spring member of the present invention is produced by subjecting the alloy high in mechanical strength and in fatigue strength to cold working or subjecting to cold working and then to aging treatment, thereby intensifying the mechanical strength. Thus, the spring member can be used as a substitution for a conventional spring produced by winding a wire rod, even though the spring member is a plate-like spring produced by forming into a desired shape.

### BRIEF DESCRIPTION OF THE DRAWINGS

In the accompanying drawings:

FIGS. 1A and 1B are views each illustrating a spring member in a first embodiment of the present invention, FIG. 1A being a plan view, and FIG. 1B being a cross-sectional view taken along the line A-A of FIG. 1A;

FIGS. 2A, 2B, and 2C are views each illustrating a spring member in a second embodiment of the present invention, FIG. 2A being a plan view, FIG. 2B being a cross-sectional view taken along the line B-B of FIG. 2A, and FIG. 2C being a cross-sectional view taken along the line C-C of FIG. 2A;

FIG. 3 is a plan view illustrating a spring member in a third embodiment of the present invention;

FIG. 4 is a plan view of a spring member illustrating a variation example in the third embodiment of the present invention;

FIG. 5 is a graph illustrating a relationship between a rate of work and tensile strength;

FIG. 6 is a graph illustrating a relationship between tensile strength and a rate of work at each temperature in aging treatment;

FIG. 7 is a graph illustrating a relationship between tensile strength and a temperature during aging treatment for each rate of work;

FIG. 8 is a graph illustrating a relationship between hardness and a rate of work at each temperature in aging treatment;

FIG. 9 is a graph illustrating a relationship between hardness and a temperature during aging treatment for each rate of work; and

FIG. 10 is a view illustrating the characteristics of the plate material for spring and spring member of the present invention, and illustrating the characteristics of a plate material for spring and a spring member made of other materials for comparison.

### DETAILED DESCRIPTION OF THE PREFERRED EMBODIMENTS

In the case where an alloy for spring of the present invention is subjected to cold working which is carried out with low stacking fault energy when the ambient temperature of the alloy is room temperature, solute atoms, such as Mo, Nb, and Fe, whose atomic radii are larger than or close to those of Co, Ni, and Cr, each of which has an atomic radius of 1.25 Å, are strongly attracted into a dislocation core or a stacking fault of extended dislocation. Then, the segregation of the solute atoms results, leading to a difficulty in the occurrence of cross slip, and hence high work-hardening capability is expressed. That is, the effect becomes remarkable in those elements each having an atomic radius of 1.2 Å or more.

Further, a plate material for spring of the present invention is provided with a high strength characteristic through cold plastic work, and is then subjected to aging treatment at from 200° C. or more to a temperature equal to or less than a recrystallization temperature. As a result, the so-called static strain aging, which is a phenomenon in which solute atoms such as Mo, Nb, and Fe are attracted into a dislocation core or a stacking fault of extended dislocation, resulting in dislocation fixation, provides the plate material for spring with a higher strength characteristic.

It should be noted that the alloy for spring and plate material for spring of the present invention express their high work-hardening capabilities not only under room temperature but also under high temperatures, and hence the alloy for spring and the plate material for spring each have a feature that a high-temperature strength characteristic is also high.

The alloy for spring of the present invention includes, as composition in terms of weight ratio, 28 to 42% Co, 10 to 27% Cr, 3 to 12% Mo, 15 to 40% Ni, 0.1 to 1.0% Ti, 1.5% or less Mn, 0.1 to 26.0% Fe, 0.1% or less C, and inevitable impurities, and at least one kind selected from 3.0% or less Nb, 5.0% or less W, 0.5% or less Al, 0.1% or less Zr, and 0.01% or less B. The reason why the composition is limited to such range is described.

Co per se has a large work-hardening capability, and hence Co has a reducing effect on the fragility of edge cutting, an increasing effect on the fatigue strength, and an increasing effect on the high-temperature strength. However, if the content of Co is less than 28%, those effects are weakly exhibited. If the content of Co is more than 42% in this composition, a matrix becomes too hard, with the result that working on the alloy for spring becomes difficult and a face-centered cubic lattice phase becomes unstable with respect to a hexagonal close-packed lattice phase. Thus, the content of Co was set to 28 to 42%.

Cr is an essential component for ensuring the corrosion resistance and has a reinforcing effect on a matrix. However, if the content of Cr is less than 10%, the effect by which excellent corrosion resistance is provided is weakly exhibited. If the content of Cr is more than 27%, the workability on and toughness of the alloy sharply decline. Thus, the content of Cr was set to 10 to 27%.

Mo has a reinforcing effect on a matrix by forming a solid solution with the matrix, an increasing effect on the work-hardening capability, and an enhancing effect on the corrosion resistance in the coexistence with Cr. However, if the content of Mo is less than 3%, desired effects are not provided. If the content of Mo is more than 12%, the workability sharply declines and a fragile σ phase is apt to be generated. Thus, the content of Mo was set to 3 to 12%.

Ni has a stabilizing effect on a face-centered cubic lattice phase, a maintaining effect on the workability, and an enhancing effect on the corrosion resistance. However, in the composition ranges of Co, Cr, Mo, Nb, and Fe in the alloy for spring of the present invention, if the content of Ni is less than 15%, providing a stabilized face-centered cubic lattice phase is difficult. If the content of Ni is more than 40%, the mechanical strength declines. Thus, the content of Ni was set to 15 to 40%.

Ti has strong effects of deoxidation, denitrification, and desulfurization, and has a miniaturizing effect on an ingot structure. However, if the content of Ti is less than 0.1%, those effects are weakly exhibited. If the content is, for example, 1.0%, no problem occurs. If the content of Ti is too large, the amount of inclusions increases in the alloy, or an η phase (Ni₃Ti) is precipitated, resulting in a reduction in toughness. Thus, the content of Ti was set to 0.1 to 1.0%.

Mn has the effects of deoxidation and desulfurization, and a stabilizing effect on a face-centered cubic lattice phase. However, if the content of Mn is too large, the corrosion resistance and the oxidation resistance deteriorate. Thus, the content of Mn was set to 1.5% or less.

If the content of Fe is too large, the oxidation resistance declines. However, priority was given to the reinforcing effect on a matrix by forming a solid solution with the matrix rather than the decline in oxidation resistance, and hence the upper limit of the content of Fe was set to 26.0%. Thus, the content of Fe was set to 0.1 to 26.0%.

C forms a solid solution with a matrix and, in addition, has a preventing effect on grain coarsening by forming carbides with Cr, Mo, Nb, W, or the like. However, if the content of C is too large, for example, the toughness declines and the corrosion resistance deteriorates. Thus, the content of C was set to 0.1% or less.

Nb has a reinforcing effect on a matrix by forming a solid solution with the matrix and an increasing effect on the work-hardening capability. However, if the content of Nb is more than 3.0%, a σ phase or a δ phase (Ni₃Nb) is precipitated, resulting in a reduction in toughness. Thus, the content of Nb was set to 3.0% or less.

W has a reinforcing effect on a matrix by forming a solid solution with the matrix and a significant increasing effect on the work-hardening capability. However, if the content of W is more than 5.0%, a σ phase is precipitated, resulting in a reduction in toughness. Thus, the content of W was set to 5.0% or less.

Al has the effect of deoxidation and an enhancing effect on the oxidation resistance. However, if the content of Al is too large, the corrosion resistance deteriorates, for example. Thus, the content of Al was set to 0.5% or less.

Zr has an enhancing effect on the hot workability by increasing the strength of a crystal grain boundary at high temperatures. However, if the content of Zr is too large, the workability deteriorates in reverse. Thus, the content of Zr was set to 0.1% or less.

B has an improving effect on the hot workability. However, if the content of B is too large, the hot workability declines in reverse, resulting in easy break of the alloy. Thus, the content of B was set to 0.01% or less.

In addition, another alloy for spring of the present invention is the above-mentioned alloy for spring, in which Fe is incorporated at 0.1 to 3.0%, and the at least one kind is selected from 3.0% or less Nb, 5.0% or less W, 0.1% or less Zr, and 0.01% or less B.

If the content of Co is more than 42% in this composition in this alloy for spring, a matrix also becomes too hard, with the result that working on the alloy for spring becomes difficult and a face-centered cubic lattice phase also becomes unstable with respect to a hexagonal close-packed lattice phase, and hence the upper limit of the content of Co was set to 42%. Meanwhile, if the content of Fe is too large, the oxidation resistance declines, and hence the upper limit of the content of Fe was set to 3.0%. In addition, the alloy does not contain Al.

In addition, still another alloy for spring of the present invention is the above-mentioned other alloy for spring, in which 3.0% or less Nb is selected as the at least one kind.

The plate material for spring of the present invention is obtained by melting the above-mentioned alloy for spring of the present invention in a vacuum melting furnace and subjecting the molten ingot to plastic work by a general working method. After that, the resultant product is finally subjected to cold working at a rate of work of 20% or more to produce a plate-like material.

The reason why the cold working is performed at a rate of work of 20% or more is that 20% is the lower limit rate for expressing work hardening.

The plate material for spring of the present invention is a high-modulus material having a high strength characteristic provided just by being subjected to cold working. When the plate material for spring is subjected to aging treatment at a temperature of 200 to 730° C. in a vacuum or in a nonoxidizing atmosphere after the cold working, static strain aging causes age hardening, resulting in the production of a high-modulus material having a higher strength characteristic. The reason why the aging treatment is performed at a temperature of 200° C. or more is that 200° C. is the lower limit temperature for expressing the age hardening. The reason why the aging treatment is performed at a temperature of 730° C. or less is that a temperature in excess of 730° C. leads to recrystallization, causing the start of the softening of the plate material.

A spring member of the present invention is formed from the above-mentioned plate material for spring of the present invention by unwinding work, has the same thickness as that of the plate material, and extends in a plane direction of the plate material.

The spring member has high mechanical strength and high fatigue strength even though the spring member is a plate-like spring member produced by punching work, laser-cut work, or the like.

Next, embodiments of the spring member of the present invention are described based on drawings.

### (FIRST EMBODIMENT)

### (Spring Member)

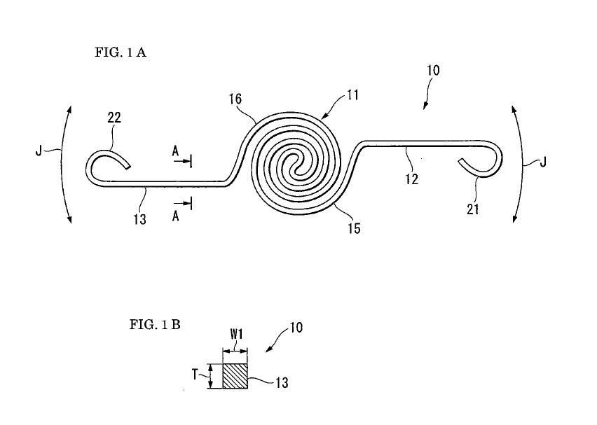

FIGS. 1A and 1B are views each illustrating a spring member in a first embodiment, FIG. 1A being a plan view, and FIG. 1B being a cross-sectional view taken along the line A-A of FIG. 1A.

As illustrated in FIGS. 1A and 1B, a spring member 10 of this embodiment is one formed in an integrated fashion by, as described later, subjecting a plate material made of an alloy to unwinding work such as punching work or laser-cut work. To be specific, the spring member 10 extends along the plane direction (paper surface direction in FIGS. 1A), and is provided with a pair of arm portions 12 and 13 configured so that elastic bending is possible in the plane direction, and a whorl-like spiral portion (elastic portion) 11, which is formed to the arm portions 12 and 13 in an integrated fashion and energizes and restores the arm portions 12 and 13 at the time of the elastic bending. Further, the spring member 10 is formed point-symmetrically with the center of the spiral portion 11 as the symmetrical point. It should be noted that, as illustrated in FIG. 1B, the spring member 10 is formed so as to have a rectangular cross section whose shape is uniform along the extending direction, with the width size W1 (short direction in the planar view of the spring member 10) and the thickness size T (size in the direction perpendicular to the plane) being identical.

The spiral portion 11 is provided with a pair of spirally stretching portions 15 and 16 (curved portions), each of which is spirally stretching so that a spiral gradually has a larger diameter toward a more outer side in the diameter direction. Each of the spirally stretching portions 15 and 16 is formed so as to be continuously curving in the same direction, and their base edges (inner edge portions) are connected with each other in the center of the spiral portion 11. That is, the spring member 10 of this embodiment is the spring member 10 in which the spiral portion 11 (spirally stretching portions 15 and 16) is formed on a plane (in a two-dimensional fashion). On the other hand, the respective end (outer edge portion) sides of the spirally stretching portions 15 and 16 are arranged so as to be opposed to each other with the spiral portion 11 sandwiched in the diameter direction. Further, the base edge sides of the arm portions 12 and 13 are formed in an integrated fashion directly to the ends of the spirally stretching portions 15 and 16, respectively. The spiral portion 11 including the respective spirally stretching portions 15 and 16 continuously curving spirally is formed, and hence the spring member 10 can be used as a spring member having a strong energizing force for energizing the arm portions 12 and 13. It should be noted that the energizing force of the spring member 10 (arm portions 12 and 13) can be controlled depending on the number of windings in the spiral portion 11 (spirally stretching portions 15 and 16).

The respective arm portions 12 and 13 extend in the reverse directions with respect to each other from the respective ends of the spirally stretching portions 15 and 16 along the diameter direction of the spiral portion 11. The respective arm portions 12 and 13 are arranged in parallel with each other and are configured so that elastic bending is possible along the width direction (see the arrow J in FIG. 1A).

The respective arm portions 12 and 13 are provided with connection portions 21 and 22, which are formed in an integrated fashion directly to the ends of the arm portions 12 and 13, respectively. The connection portions 21 and 22 are configured so that the ends of the arm portions 12 and 13 are each formed so as to have a hook shape and that various devices are connected to the insides of the connection portions 21 and 22.

One of the connection portions 21 and 22 in the above-mentioned spring member 10 is connected to a fixed member and the other connection portion is connected to a movable member, and hence the spring member 10 can be used in a hinge mechanism or the like. The spring member 10 of this embodiment can be used in, for example, a sliding mobile phone. In the mobile phone, a body provided with an operation key and a transmission part and a lid body arranged so as to overlap the body and provided with a display and a receiver part are relatively slid along the overlapped faces of two bodies by using the hinge mechanism, thereby opening or closing the mobile phone. To be specific, one of the respective connection portions is connected to the body and the other connection portion is connected to the lid body, and thus, the body and the lid body relatively move. As a result, as described above, the elastic bending of the arm portions 12 and 13 in the spring member 10 occurs. The sliding mobile phone has such a configuration that by using the restoring force (energizing force) of the elastic bending, the lid body is energized in an opening direction or in a closing direction.

### (Alloy)

Here, the above-mentioned spring member is produced from, for example, an alloy that includes, as its composition in terms of weight ratio, 28 to 42% Co, 10 to 27% Cr, 3 to 12% Mo, 15 to 40% Ni, 0.1 to 1.0% Ti, 1.5% or less Mn, 0.1 to 3.0% Fe, 3.0% or less Nb, 0.1% or less C, and inevitable impurities.

### (Methods of Producing Spring Member)

Next, methods of producing the above-mentioned spring member 10 are described.

First, the alloy including the composition described above is melt in a vacuum melting furnace, and the molten ingot is subjected to plastic work by a general working method. In this case, cold plastic work is performed at room temperature at a rate of work (rate between the cross-sectional areas before work and after work) of at least 20%, thereby producing a plate-like plate material formed so as to have the same thickness as the thickness size T of the spring member 10 having its completed shape (cold working step). Setting the rate of work (rate of cold work) at 20% or more as described above can increase the hardness and tensile strength of the alloy. Therefore, an excellent spring member 10 having higher mechanical strength can therefore be produced. It should be noted that the rate of work is set more preferably at 40% or more.

Further, the above-mentioned plate material made of the alloy is subjected to unwinding work such as punching work or laser-cut work (forming step). As a result, the alloy is formed into the shape of the above-mentioned spring member 10.

By the way, the above-mentioned Co-Ni alloy is a high-modulus alloy having an excellent strength characteristic provided just by being subjected to cold working. In this embodiment, the spring member 10 is subjected to aging treatment at a temperature from 200° C. or more to 730° C. or less in a vacuum or in a nonoxidizing atmosphere after the above-mentioned forming step is carried out (heat treatment step). As a result, when the spring member 10 formed from the cold-worked plate material is further subjected to the aging treatment, static strain aging causes age hardening, resulting in the production of a high-modulus alloy having higher mechanical strength. Thus, a more excellent spring member 10 can be provided.

In particular, the aging treatment is carried out at a temperature of at least 200° C., and hence the age hardening of the alloy can be expressed for sure. On the other hand, the upper limit is to set to 730° C. or less, and hence the softening of the alloy caused by its recrystallization can be prevented. It should be noted that a more desirable temperature for aging treatment is 350° C. or more to 650° C. or less, at which sufficient age hardening and toughness are provided in optimum composition in the alloy of this embodiment.

As a result of the foregoing, the spring member 10 of this embodiment is completed.

As described above, in this embodiment, an alloy is first formed into a plate shape by cold working to produce a plate material. Next, the plate material is formed into a desired spring shape by unwinding work such as punching work or laser-cut work. Thus, a spring member 10 having a two-dimensional shape can be provided, the spring member 10 having the same thickness size T as that of the plate material and being extended in the plane direction of the plate material. That is, there can be provided the spring member 10, which has the arm portions 12 and 13 capable of elastically bending in the plane direction, and has a spiral portion 11, which is formed directly to the arm portions 12 and 13 in an integrated fashion and energizes and restores the arm portions 12 and 13 at the time of the elastic bending.

In particular, the spring member 10 is not formed by a conventional method in which a wire rod is wound in a three-dimensional fashion, but the spring member 10 is formed in a two-dimensional fashion by subjecting a flat plate material to unwinding work. Accordingly, the thickness size T of the spring member 10 can be controlled to the same thickness as that of the plate material. Thus, a reduction in thickness of the spring member 10 can be attempted.

Further, winding a wire rod is not required unlike conventional methods, and hence even a spring member having a complicated shape which was difficult to produce by a winding method can be easily produced. Thus, while a reduction in thickness is being attempted, demands for various shapes and the like can be met. Further, winding a wire rod is not required, and hence fatigue due to the winding is not accumulated. Therefore, a spring member 10 free of fatigue and excellent in durability can be produced.

In this case, this embodiment adopted such a configuration that the above-mentioned plate material made of the alloy was subjected to unwinding work such as punching work or laser-cut work.

The configuration enables the production of the spring member 10 from the plate material by unwinding work in an easy and assured manner. In particular, a spring member 10 having a complicated and fine shape can also be produced. Further, production efficiency is difficult to increase and production cost is difficult to increase, because the configuration does not include a special method.

By the way, the above-mentioned plate material or the above-mentioned spring member is produced from, for example, an alloy that includes, as its composition in terms of weight ratio, 28 to 42% Co, 10 to 27% Cr, 3 to 12% Mo, 15 to 40% Ni, 0.1 to 1.0% Ti, 1.5% or less Mn, 0.1 to 3.0% Fe, 3.0% or less Nb, 0.1% or less C, and inevitable impurities.

Thus, the plate material has a characteristic that tensile strength is high even compared with that of SUS301, which is typical stainless steel for spring. The plate material can be therefore formed into a spring member having excellent mechanical strength higher than that of a conventional spring member produced by winding a wire rod in a three-dimensional fashion.

Further, by using the spring member 10 described above in, for example, the hinge mechanisms of various devices such as sliding mobile phones, there can be provided mobile phones in each of which a smooth sliding function can be exerted and which are excellent in durability.

### (SECOND EMBODIMENT)

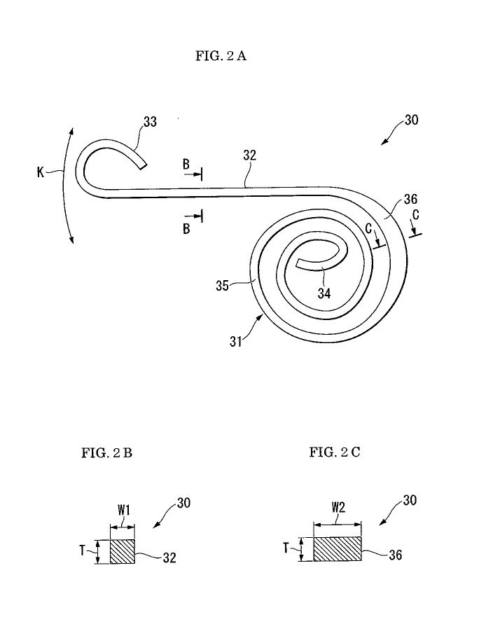

Next, a second embodiment of the present invention is described. FIGS. 2A, 2B, and 2C are views each illustrating a spring member in the second embodiment, FIG. 2A being a plan view, FIG. 2B being a cross-sectional view taken along the line B-B of FIG. 2A, and FIG. 2C being a cross-sectional view taken along the line C-C of FIG. 2A. The spring member of this embodiment is different from that of the above-mentioned first embodiment in the respect that a portion having a larger thickness is formed for ensuring strength.

As illustrated in FIGS. 2A, 2B, and 2C, a spring member 30 of this embodiment is one formed by, as in the above-mentioned first embodiment, subjecting a plate material made of an alloy to unwinding work. The spring member 30 is provided with a whorl-like spiral portion (elastic portion) 31 having a spirally stretching portion (curved portion) 35, which is spirally stretching so that a spiral gradually has a larger diameter toward a more outer side in the diameter direction, and with an arm portion 32 stretching from the outer edge portion of the spirally stretching portion 35.

The arm portion 32 extends along the tangential direction of the outermost circumferential portion of the spiral portion 31, and is configured so that elastic bending is possible along the width direction (see the arrow K in FIG. 2A). Further, the arm portion 32 is provided with a hook-like connection portion 33, which is formed directly to an end of the arm portion 32 in an integrated fashion and connected to various devices. On the other hand, a hook-like connection portion 34, which is connected to various devices, is formed at the inner end portion of the spirally stretching portion 35. Further, one of the connection portions 33 and 34 is connected to a fixed member and the other connection portion is connected to a movable member.

Here, the outermost circumferential portion of the spirally stretching portion 35 is provided with a large-width portion 36, which has a larger width size than those of other sections (for example, the arm portion 32 and the inner circumferential portion of the spirally stretching portion 35). To be specific, the large-width portion 36 is formed so that the connection part of the large-width portion 36 to the arm potion 32 and the connection part to the spirally stretching portion 35 make a given angle range (for example, about 180° as the central angle of the spiral portion 31). Further, the large-width portion 36 is formed so that the large-width portion gradually has a larger width size toward the middle part from both the edge portions in the circumferential direction. To be specific, as illustrated in FIG. 2C, the large-width portion 36 is formed so that the width size W2 is larger than the thickness size T (that is, the rate of thickness size T/width size W2 is less than 1.0). In this case, the portion with the largest width (middle of the large-width portion 36 in the circumferential direction) in the large-width portion 36 is formed so as to have the width size W2 equivalent to roughly double the thickness size T. It should be noted that the spiral portion 31 of this embodiment is formed of the spirally stretching portion 35, the large-width portion 36, and the connection portion 34.

The configuration described above exerts the same effect as that of the above-mentioned first embodiment. Further, in the configuration, the width size W2 of the outermost circumferential side of the spirally stretching portion 35, where stress concentration is apt to occur at the time of the elastic bending of the arm portions 12 and 13, is larger than the width size W1 of the inner circumferential side, and hence the strength of the spirally stretching portion 35 can be further intensified and the durability can be enhanced. In this case, the width size W2 becomes larger with respect to the thickness size T of the spirally stretching portion 35, and hence the mechanical strength can be further intensified while a reduction in thickness is being attempted. Thus, a thin, strong spring member 10 can be provided.

In addition, the large-width portion 36 is formed only at the portion (outermost circumferential side of the spirally stretching portion 35) where stress concentration is apt to occur, and hence the strength of the spring member 30 can be ensured while a reduction in thickness of the spring member 30 is being attempted, compared with the case where the whole spring member 30 is formed so as to have a larger width.

Further, the large-width portion 36 is formed in such a way that the width size is gradually becoming larger toward the middle part from both the edges in the circumferential direction, and hence there is no unevenness or the like at the connection parts of the large-width portion 36, and a smoothly curved shape is formed. Thus, stress concentration can be prevented at the connection parts of the large-width portion 36.

### (THIRD EMBODIMENT)

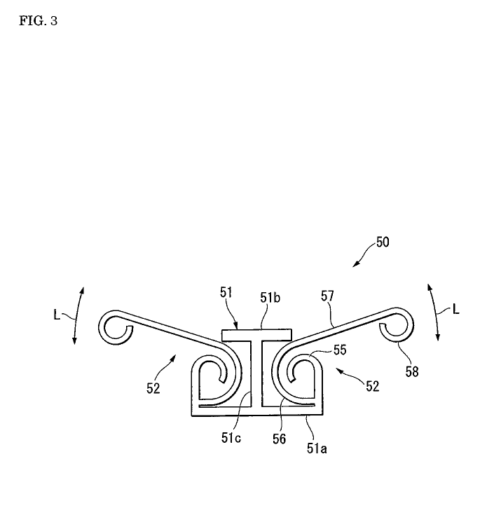

Next, a third embodiment of the present invention is described. FIG. 3 is a plan view illustrating a spring member of the third embodiment. The spring member of this embodiment is different from that of the above-mentioned first embodiment in the respect that a pair of sets of an arm portion and an elastic portion, both of which can elastically bend, is formed in an integrated fashion with respect to a base portion.

As illustrated in FIG. 3, a spring member 50 of the third embodiment is provided with a base portion 51 having an H shape in the planar view, and with a pair of sets of an elastic portion 52 and an arm portion 57, which are formed directly to the base portion 51 in an integrated fashion. It should be noted that the spring member 50 of this embodiment is formed line-symmetrically with the central line of the base portion 51 as the symmetrical line.

The base portion 51 is formed of a first extending portion 51a and a second extending portion 51b, both of which extend in parallel with each other, and of a bridging portion 51c formed so as to bridge the first extending portion 51a and the second extending portion 51b.

Respective sets of the elastic portion 52 and arm portion 57 are formed at each of both the edge portions of the first extending portion 51a in the longitudinal direction. It should be noted that the respective sets of the elastic portion 52 and arm portion 57 are members symmetrical with each other with respect to the base portion 51, and hence one of the elastic portions 52 is mentioned in the following description.

The elastic portion 52 is provided with a hook-like connection portion 55 extending from one of the edge portions of the first extending portion 51a in the longitudinal direction, and with a curved portion 56, which is formed in an in-between portion of the connection portion 55 and curves so as to surround the connection portion 55.

Further, the arm portion 57 is formed directly to an end of the curved portion 56 in an integrated fashion, and a connection portion 58 to be connected to various devices is formed at an end of the arm portion 57. Further, the arm portion 57 is configured so as to be able to elastically bend and be deformable along the width direction (see the arrow L in FIG. 3).

The configuration described above can exert the same effect as that of the above-mentioned first embodiment, and can form a pair of the elastic portions 52 directly to the base portion 51 in an integrated fashion. Accordingly, a further reduction in size of the spring member 50 can be attempted.

Further, the spring member 50 of this embodiment is formed by, as in the above-mentioned first embodiment, subjecting a flat plate made of an alloy to unwinding work such as punching work or laser-cut work. Thus, winding a wire rod is not required unlike conventional methods, and hence even such a spring member as the spring member 50 of this embodiment can be produced by easily forming a flat plate into a desired spring shape only by punching the flat plate, the spring member 50 having a complicated shape which was difficult to produce by a winding method. Thus, while a reduction in thickness is being attempted, demands for various shapes and the like can be met.

### (VARIATION EXAMPLE)

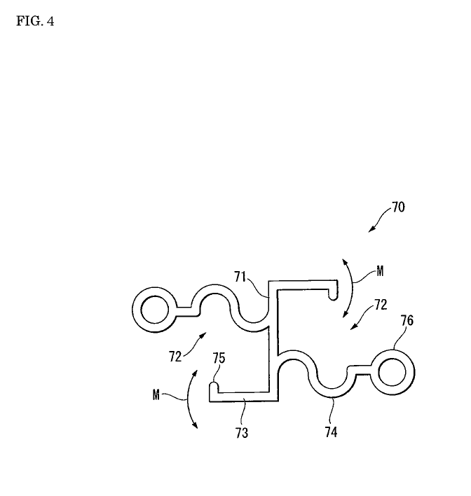

Further, such a shape as illustrated below can also be adopted as a spring member of the present invention. FIG. 4 is a plan view of a spring member illustrating another configuration of the present invention.

A spring member 70 illustrated in FIG. 4 is provided with a base portion 71 having a slender shape and with a pair of sets of an elastic portion 72 and an arm portion 73, which are formed directly to the base portion 71 in an integrated fashion. It should be noted that the spring member 70 of this embodiment is formed point-symmetrically with the center of the base portion 71 as the symmetrical point. Further, respective sets of the elastic portion 72 and arm portion 73 are members symmetrical with each other with respect to the symmetrical point, and hence one of the elastic portions 72 is mentioned in the following description.

The elastic portion 72 is provided with a ripple portion (curved portion) 74 extending while snaking from an in-between portion of the base portion 71 in the longitudinal direction, and with a ring portion 76, which is formed directly to an end of the ripple portion 74 and to which various devices are connected.

The arm portion 73 extends from an end portion of the base portion 71 in the longitudinal direction along the width direction of the base portion 71. Formed at an end of the arm portion 73 is a protruding portion 75, which protrudes so as to be perpendicular to the extending direction of the arm portion 73, and various devices are engaged with the protruding portion 75. Further, the arm portion 73 is configured so as to be able to elastically bend along the plane direction (see the arrow M in FIG. 4).

The configuration described above can exert the same effect as that of the above-mentioned first embodiment.

It should be noted that the technical scope of the present invention is not limited to the above-mentioned embodiments, and includes modes obtained by modifying the above-mentioned embodiments in various ways as long as those modes do not depart from the gist of the present invention. That is, specific structures, shapes, and the like exemplified in the embodiments are just some examples, and can arbitrarily undergo any modification.

The spring members of these embodiments can be adopted, for example, not only in hinge mechanisms used in sliding mobile phones but also in various devices. In this case as well, each of the spring members of those embodiments can be produced by forming a flat plate made of an alloy into a desired spring shape only by punching the flat plate. Thus, while reductions in size and thickness are being attempted, demands for various shapes, various sizes, and the like can be immediately met.

Further, the above-mentioned large-width portion may be adopted in the spring member of each embodiment. For example, the large-width portion 36 of the above-mentioned second embodiment may be formed in each of the curved portions (spirally stretching portions 15 and 16, curved portion 56, and ripple portion 74). As a result, the strength of each curved portion can be further intensified and the durability can be enhanced.

### (EXAMPLE)

Next, spring members according to the present invention are actually produced, and examples in which the mechanical strengths of the spring members are compared are described.

First, the following alloys were adopted in this example.

That is, used was an alloy containing, as its composition, inevitable impurities and, in terms of weight ratio, 34.07% Co, 19.96% Cr, 10.06% Mo, 32.33% Ni, 0.5% Ti, 0.3% Mn, 1.77% Fe, 1.01% Nb, and 0.018% C.

The alloy was then subjected to cold working to produce a plate material.

After that, the plate material was subjected to unwinding work by punching work to form the shape of the spring member 10 shown in the first embodiment. Hereinafter, the spring member in this state is described as “Example 1.”

In addition, after the above-mentioned punching forming, aging treatment was carried out in a vacuum at a temperature of 525° C. to produce a spring member. Hereinafter, the spring member in this state is described as “Example 2.”

On the other hand, SUS301 famous as SUS-based steel for spring was used to produce a spring member having the same shape as that of the above-mentioned spring member 10. Hereinafter, the spring member in this state is described as “Comparative Example.”

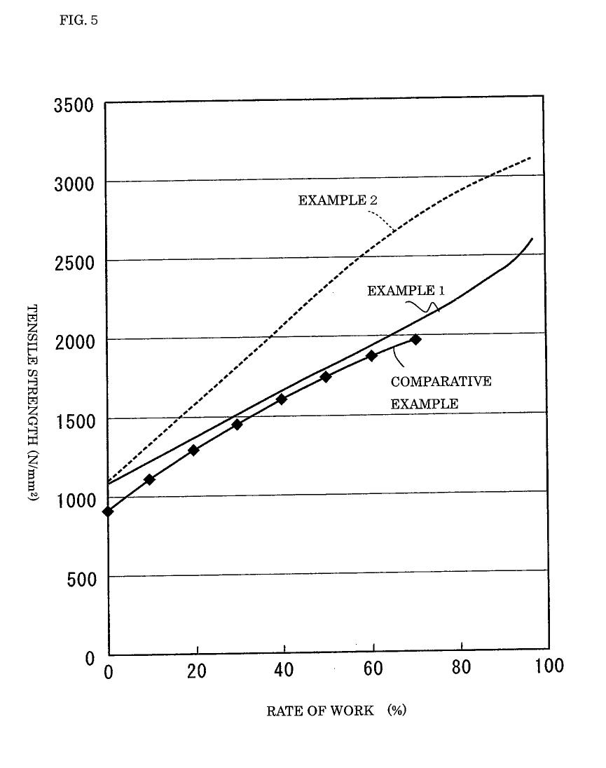

Next, the tensile strengths of respective examples and Comparative Example were compared. The results are illustrated in FIG. 5. This FIG. 5 is a graph illustrating a relationship between a rate of work and tensile strength.

As illustrated in FIG. 5, all cases show that, as the rate of work increases, the tensile strength tends to increase as well. In particular, it was confirmed that the spring member of Example 1 that had been produced by using the alloy according to the present invention was high in tensile strength irrespective of the rate of work, compared with the spring member made of SUS301 exemplified as Comparative Example. Further, provided was such a result that the spring member of Example 2 obtained by subjecting the spring member of Example 1 to aging treatment was higher in tensile strength. For example, the case where Example 2 was subjected to cold working at a rate of work of about 60% shows that the resultant spring member had tensile strength higher by 30% or more than that in the case where Comparative Example was subjected to cold working at a rate of work of about 60%.

Those results show that the spring members according to the present invention are high in mechanical strength and each have sufficient durability even though the spring members each had a two-dimensional structure.

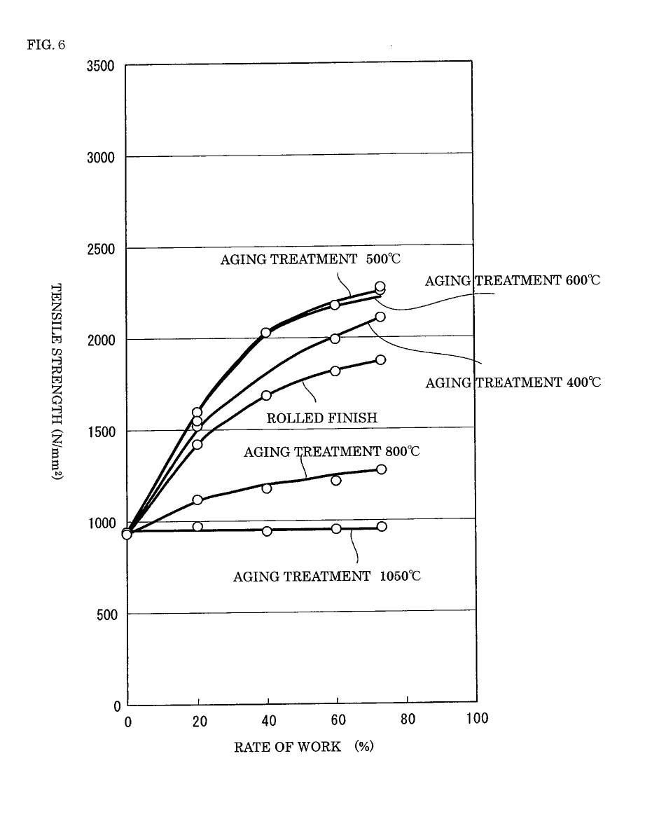

Next, various experiments were carried out on the mechanical properties of the alloy including the above-mentioned composition according to the present invention. The results of the experiments are illustrated in FIGS. 6 to 9.

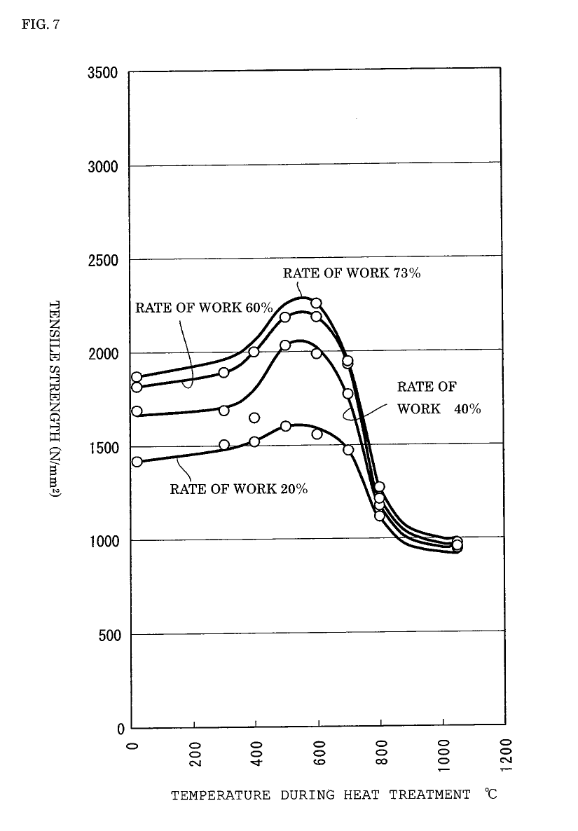

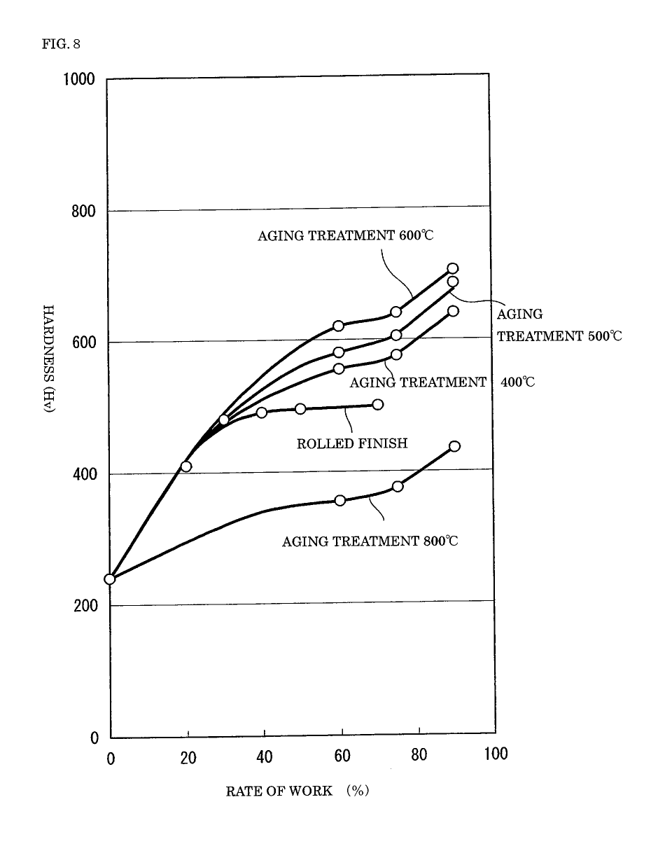

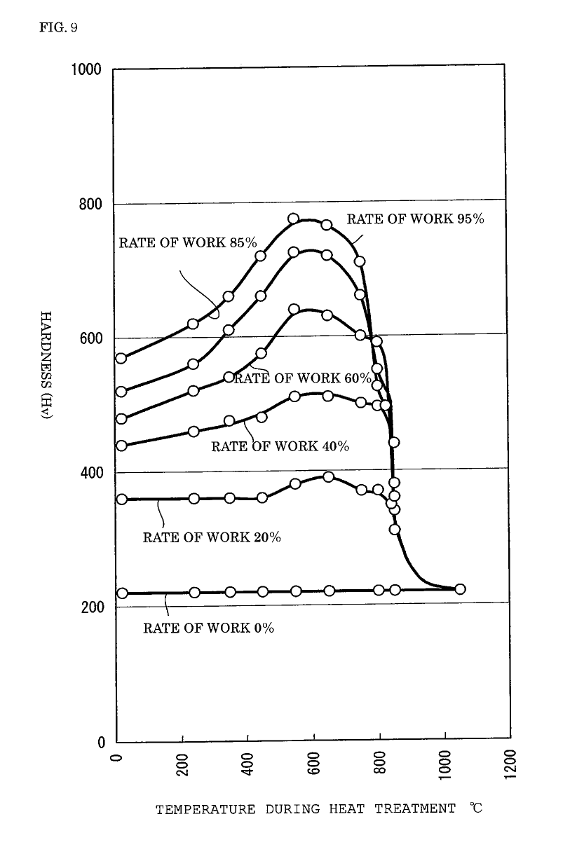

FIG. 6 is a graph illustrating a relationship between tensile strength and a rate of work at each temperature in aging treatment. FIG. 7 is a graph illustrating a relationship between tensile strength and a temperature during aging treatment (temperature during heat treatment) for each rate of work. FIG. 8 is a graph illustrating a relationship between hardness (Vickers hardness) and a rate of work at each temperature in aging treatment. FIG. 9 is a graph illustrating a relationship between hardness and a temperature during aging treatment (temperature during heat treatment) for each rate of work.

As illustrated in those FIGS. 6 and 8, it was confirmed that, even in the case where no aging treatment had been carried out (rolled finish), subjecting the alloy to cold working caused work hardening of the alloy, resulting in enhancement in both tensile strength and hardness of the alloy. In particular, as illustrated in FIG. 8, it was confirmed that tensile strength effectively increased at a rate of work of at least 20%. Thus, it is preferred that cold working be carried out at a rate of work of at least 20% during the step of cold working.

Next, as illustrated in FIGS. 6 to 9, it was confirmed that performing aging treatment afterwards resulted in further enhancement in both tensile strength and hardness. In particular, the results in the figures show that the tensile strength and hardness started to largely increase at about 350° C., and the values of the tensile strength and hardness reached their peaks at about 560° C., followed by the decreases of the values. Further, it was confirmed that, after the temperature of the aging treatment exceeded 800° C., the tensile strength and hardness decreased in reverse. This is probably because a temperature exceeding 730° C. causes the recrystallization of the alloy, leading to the start of the softening of the alloy. Further, it was confirmed that, after the temperature of the aging treatment exceeded 200° C., effective increases in tensile strength and hardness were attained. This is probably because a temperature exceeding 200° C. can certainly cause the age hardening to express on the alloy.

In view of the foregoing, it is preferred that aging treatment be performed at temperatures from 200° C. or more to 730° C. or less during the step of heat treatment.

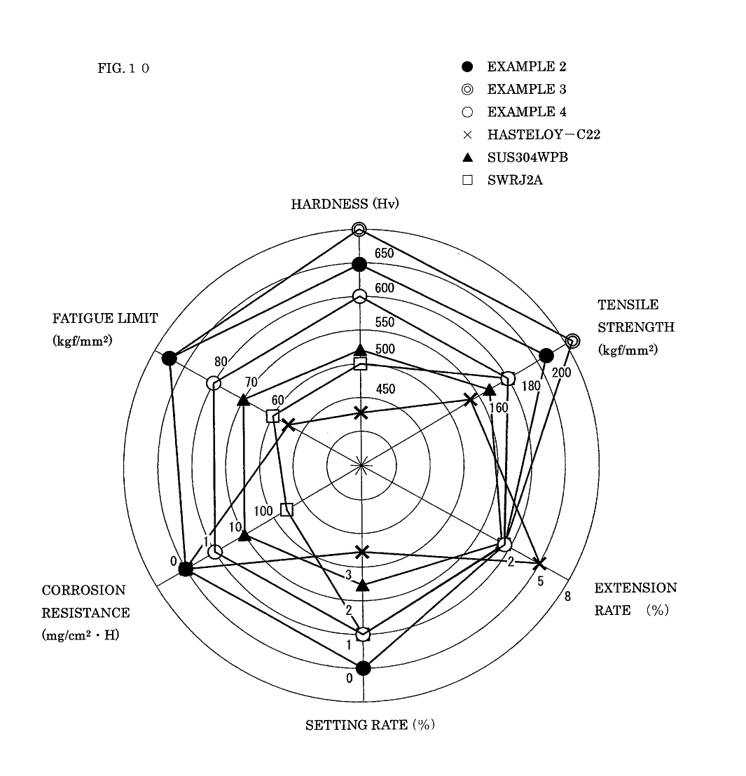

Next, comparison was made on tensile strength, hardness, fatigue limit, and corrosion resistance (degree of corrosion), by using the same plate material as that used in Example 2 described above, Examples 3 and 4 as other plate materials of the present invention, and plate materials each made of one of the comparative materials (HASTELOY (registered trademark) C22, SUS304WPB, and SWRJ2A). Then, comparison was made on an extension rate and a setting rate by using the spring members of Examples 2, 3, and 4, and the spring members each made of one of the comparative materials described above. FIG. 10 illustrates all the results of the comparisons.

An alloy having the following composition was used in Example 3.

That is, used was an alloy containing, as its composition, inevitable impurities and, in terms of weight ratio, 33.56% Co, 22.84% Cr, 9.06% Mo, 29.90% Ni, 0.49% Ti, 0.31% Mn, 1.66% Fe, 0.52% Nb, 1.55% W, 0.02% Zr, 0.005% B, and 0.04% C.

Further, an alloy having the following composition was used in Example 4.

That is, used was an alloy containing, as its composition, inevitable impurities and, in terms of weight ratio, 38.40% Co, 11.70% Cr, 4.00% Mo, 16.50% Ni, 0.58% Ti, 0.75% Mn, 23.08% Fe, 4.01% W, 0.06% Al, and 0.018% C.

It was confirmed from FIG. 10 that the plate materials of Examples 2 and 3 were better in most characteristics among tensile strength, hardness, fatigue limit, and corrosion resistance than the plate materials each made of one of the comparative materials. The corrosion resistance of each of the plate materials of Examples 2 and 3 was almost the same as that of the plate material made of HASTELOY (registered trademark) C22.

Further, it was confirmed that the plate material of Example 4 was inferior in corrosion resistance to that made of HASTELOY (registered trademark) C22, was almost identical in tensile strength to that made of SWRJ2A, and was better in all other characteristics than the plate materials each made of one of the comparative materials.

It should be noted that the plate materials of Examples 2 and 3 were better in all characteristics including tensile strength, hardness, fatigue limit, and corrosion resistance than the plate material of Example 4, and the plate material of Example 3 was higher in each of tensile strength and hardness than the plate material of Example 2 by about 10%.

Meanwhile, when comparison was made on springs, all the springs of Examples 2 to 4 were smaller in extension rate than that made of HASTELOY (registered trademark) C22, but were almost identical in extension rate to those each made of one of the other comparative materials.

On the other hand, it was confirmed that all the springs of Examples 2 to 4 were better in setting rate than those made of other materials.

It should be noted that Examples 2 and 3 were better than Example 4.

What is claimed is:

1. An alloy for spring, comprising, as composition in terms of weight ratio, 28 to 42% Co, 10 to 27% Cr, 3 to 12% Mo, 15 to 40% Ni, 0.1 to 1.0% Ti, 1.5% or less Mn, 0.1 to 26.0% Fe, 0.1% or less C, and inevitable impurities, and at least one kind selected from 3.0% or less Nb, 5.0% or less W, 0.5% or less Al, 0.1% or less Zr, and 0.01% or less B.

2. An alloy for spring according to claim 1, wherein Fe is comprised at 0.1 to 3.0%, and the at least one kind is selected from 3.0% or less Nb, 5.0% or less W, 0.1% or less Zr, and 0.01% or less B.

3. An alloy for spring according to claim 2, wherein 3.0% or less Nb is selected as the at least one kind.

4. A plate material for spring, wherein the plate material for spring is formed by subjecting the alloy for spring according to claim 1 to cold working into a plate shape at a rate of work of 20% or more.

5. A plate material for spring, wherein the plate material for spring is formed by subjecting the alloy for spring according to claim 2 to cold working into a plate shape at a rate of work of 20% or more.

6. A plate material for spring, wherein the plate material for spring is formed by subjecting the alloy for spring according to claim 3 to cold working into a plate shape at a rate of work of 20% or more.

7. A plate material for spring, wherein the plate material for spring is formed by subjecting the plate material for spring according to claim 4 to heat treatment at from 200° C. to 730° C. in one of a vacuum and a nonoxidizing atmosphere.

8. A spring member, wherein the spring member is formed from the plate material for spring according to claim 4 by unwinding work, has the same thickness as a thickness of the plate material, and extends in a plane direction of the plate material.

9. A spring member, wherein the spring member is formed from the plate material for spring according to claim 7 by unwinding work, has the same thickness as a thickness of the plate material, and extends in a plane direction of the plate material.
